(19) United States
(12) Patent Application Publication
(10) Pub. No.: US 2019/0005331 A1
(43) Pub. Date: Jan. 3, 2019

(54) APPARATUS AND METHOD FOR DETECTING EVENT BASED ON DETERMINISTIC FINITE AUTOMATA IN SOCCER VIDEO

(71) Applicant: ELECTRONICS AND TELECOMMUNICATIONS RESEARCH INSTITUTE, Daejeon (KR)

(72) Inventor: Ji Won LEE, Daejeon (KR)

(21) Appl. No.: 15/840,076

(22) Filed: Dec. 13, 2017

(30) Foreign Application Priority Data
Jun. 29, 2017 (KR) 10-2017-0082924
Dec. 4, 2017 (KR) 10-2017-0164900

(51) Int. Cl. G06K 9/00; G06T 7/73; G06T 7/246; G06T 7/62

(52) U.S. Cl. CPC G06K 9/00724; G06T 7/73; G06T 7/246; G06T 2207/30196; G06T 2207/30224; G06T 2207/10016; G06T 7/62

(57) ABSTRACT

An apparatus and method for detecting an event includes extracting at least one of position information and motion information of at least one object from a soccer video including the at least one object, causing a state of the at least one object to transition based on at least one of the position information and the motion information of the at least one object according to object-specific state transition rules, and when the state of the at least one object becomes a final state, detecting a soccer event corresponding to the final state. Accordingly, it is possible to concretely and accurately recognize events that may occur in a soccer game using deterministic finite automata (DFA) pre-determined according to object.

### CROSS-REFERENCE TO RELATED APPLICATIONS

This application claims priority to Korean Patent Application No. 2017-0082924, filed Jun. 29, 2017, and Korean Patent Application No. 2017-0164900, filed Dec. 4, 2017, in the Korean Intellectual Property Office (KIPO), the entire contents of which are hereby incorporated by reference.

### BACKGROUND

### 1. Technical Field

Example embodiments of the present invention relate in general to an apparatus and method for detecting an event based on deterministic finite automata (DFA) in a soccer video and more specifically to an apparatus and method for concretely detecting an even that occurs in a soccer video based on position and motion information of an object.

### 2. Description of Related Art

Methods of recognizing an event in a soccer video may be roughly classified into a method of recognizing a situation in which a main event occurs and a method of recognizing a situation in which each individual event occurs.

First, the method of recognizing a situation in which a main event occurs involves patterning a camera recording style and vocal styles of a commentator and a stadium in advance, learning the patterns, and attempting to detect situations in which main events including shootings, fouls, and the like occur in a game. However, in this method, each soccer event is not determined based on actions of objects including players and referees who run in a game, but audio and/or video clues are detected from a broadcasting video of a game and used to only recognize whether a main event has occurred. Since motions of players and referees are not accurately identified in this method, it is not possible to recognize an event itself. In other words, each event is not accurately classified or analyzed; rather, assuming that there will be a main event at a corresponding time point, there is no choice but to focus on producing a highlight video including the corresponding time point.

On the other hand, the method of recognizing a situation in which each individual event occurs involves distinguishing and recognizing a defined specific event based on accurate information such as a position of an object in a soccer game. In this method, it is possible to separately distinguish a game event using positions of a ball and players in a game. However, referees participating in the game are not tracked, and it is not possible to recognize events based on motions of objects including a referee, assistant referees, players that have decisive influence on the game, such as a hand motion of the referee, a flag motion of an assistant referee, and the like. Therefore, the number of recognizable events is limited. In addition, this method also lacks concreteness and accuracy.

Consequently, there is a necessity of a method for concretely and accurately determining an individual soccer event based on position and motion information of objects that are directly related to a game, such as players, referees, and a ball.

### SUMMARY

Accordingly, example embodiments of the present invention are provided to substantially obviate one or more problems due to limitations and disadvantages of the related art.

Example embodiments of the present invention provide an apparatus for detecting event based on deterministic finite automata in soccer video.

Example embodiments of the present invention also provide a method for detecting event based on deterministic finite automata in soccer video.

In some example embodiments, a method of detecting an event comprises extracting at least one of position information and motion information of at least one object from a soccer video including the at least one object, causing a state of the at least one object to transition based on at least one of the position information and the motion information of the at least one object according to object-specific state transition rules, and when the state of the at least one object becomes a final state, detecting a soccer event corresponding to the final state.

The method further comprises until a soccer game is finished, repeatedly performing the extracting of the at least one of the position information and the motion information, the causing of the state of the at least one object to transition, and the detecting of the soccer event.

The causing of the state of the at least one object to transition according to the object-specific state transition rules comprises causing the state of the at least one object to transition using pre-defined object-specific deterministic finite automata (DFA).

The extracting of the at least one of the position information and the motion information comprises extracting the position information and size information of the at least one object from the soccer video by tracking the at least one object.

The extracting of the at least one of the position information and the motion information further comprises extracting motion information of the at least one object based on the position information and the size information of the at least one object.

The extracting of the motion information of the at least one object based on the position information and the size information comprises classifying the position information and the size information of the at least one object according to object and extracting object-specific motion information based on the position information and the size information classified according to object.

The causing of the state of the at least one object to transition according to the object-specific state transition rules comprises, when the object is a ball, causing a state of the ball to transition based on a distance between the ball and a specific player, a directional change of the ball, and a speed of the ball according to state transition rules of the ball.

The method further comprises recording the detected event corresponding to the final state together with detailed information of the event.

The detailed information of the event includes at least one of a name of the event, a start frame number of the event, an end frame number of the event, a name of a player who has caused the event, a name of a player who has ended the event, a name of a team that has caused the event, a position at which the event has occurred, and a name of a referee or an assistant referee who has caused the event.

The soccer event corresponding to the final state includes any one of foul, card, free kick, and penalty kick when the object is a referee, includes any one of substitution, line out, goal-line out, offside, corner kick, and foul when the object is an assistant referee, includes any one of heading and tackle when the object is a player, and includes any one of pass, corner kick, penalty kick, shooting, goal, and assist when the object is a ball. In some example embodiments, an apparatus for detecting an event comprises a processor and a memory configured to store at least one command executed by the processor, the at least one command is executed to extract at least one of position information and motion information of at least one object from a soccer video including the at least one object, to cause a state of the at least one object to transition based on at least one of the position information and the motion information of the at least one object according to object-specific state transition rules, and to detect a soccer event corresponding to a final state when the state of the at least one object becomes the final state.

The at least one command is executed to repeatedly extract at least one of the position information and the motion information, repeatedly cause the state of the at least one object to transition, and repeatedly detect the soccer event until a soccer game ends.

The at least one command is executed to cause the state of the at least one object to transition using pre-determined object-specific deterministic finite automata (DFA).

The at least one command is executed to extract the position information and size information of the at least one object from the soccer video by tracking the at least one object.

The at least one command is executed to extract motion information of the at least one object based on the position information and the size information of the at least one object.

The at least one command is executed to classify the position information and the size information of the at least one object according to object and to extract object-specific motion information based on the position information and the size information classified according to object.

The at least one command is executed to cause, when the at least one object is a ball, a state of the ball to transition based on a distance between the ball and a specific player, a directional change of the ball, and a speed of the ball according to state transition rules of the ball.

The at least one command is executed to record the detected event corresponding to the final state together with detailed information of the event.

The detailed information of the event includes at least one of a name of the event, a start frame number of the event, an end frame number of the event, a name of a player who has caused the event, a name of a player who has ended the event, a name of a team that has caused the event, a position at which the event has occurred, and a name of a referee or an assistant referee who has caused the event.

The soccer event corresponding to the final state includes any one of foul, card, free kick, and penalty kick when the object is a referee, includes any one of substitution, line out, goal-line out, offside, corner kick, and foul when the object is an assistant referee, includes any one of heading and tackle when the object is a player, and includes any one of pass, corner kick, penalty kick, shooting, goal, and assist when the object is a ball.

According to the present invention, an event recognition DFA of each object is defined based on inputs of a position and a motion of the object, and thus it is possible to concretely and accurately recognize each event that may occur in a soccer game.

According to the present invention, it is possible to recognize a high dimensional soccer game strategy that may be a set of positions, motions, and events of individual objects.

An example embodiment of an apparatus for detecting an event according to the present invention can be applied to any sports in which events of similar patterns occur, and can be used in application fields based on image understanding such as closed-circuit television (CCTV)-based action analysis.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram of a method of detecting an event according to an example embodiment of the present invention.

FIG. 2 is a block diagram of an apparatus for detecting an event according to an example embodiment of the present invention.

FIG. 3 is a state transition function table of a referee deterministic finite automaton (DFA) according to an example embodiment of the present invention.

FIG. 4 is a diagram showing a referee DFA according to an example embodiment of the present invention.

FIG. 5 is a diagram showing an assistant referee DFA according to an example embodiment of the present invention.

FIG. 6 is a diagram showing a player DFA according to an example embodiment of the present invention.

FIG. 7 is a diagram showing a ball DFA according to an example embodiment of the present invention.

FIG. 8 is a flowchart of a method of detecting an event according to an example embodiment of the present invention.

FIG. 9 shows detailed event information of shooting, pass, and tackle according to an example embodiment of the present invention.

FIG. 10 shows detailed event information of corner kick, free kick, and penalty kick according to an example embodiment of the present invention.

FIG. 11 shows detailed event information of offside, foul, and card according to an example embodiment of the present invention.

FIG. 12 shows detailed event information of assist, substitution, and line out according to an example embodiment of the present invention.

FIG. 13 shows detailed event information of goal-line out, heading, and goal according to an example embodiment of the present invention.

### DETAILED DESCRIPTION OF EXAMPLE EMBODIMENTS

Example embodiments of the present invention are disclosed herein. However, specific structural and functional details disclosed herein are merely representative for purposes of describing example embodiments of the present invention, and example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

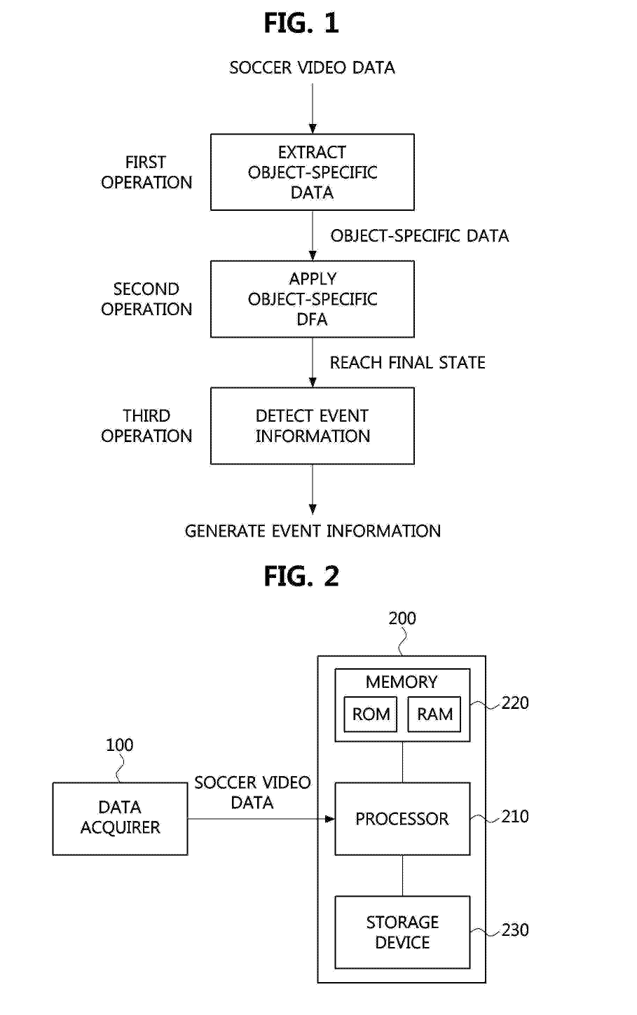

FIG. 1 is a conceptual diagram of a method of detecting an event according to an example embodiment of the present invention.

Description of the present invention relates to a method of detecting 15 main soccer events including main soccer events that are defined and used by Federation International de Football Association (FIFA). However, this is assumed for convenience of description, and the types and number of detectable events are not limited thereto.

Events detectable by an apparatus for detecting an event according to an example embodiment of the present invention may include assist, shooting, goal, free kick, corner kick, penalty kick, foul, warning (yellow card), sending off (red card), and offside, and may further include substitution, line out, goal-line out, tackle, and heading as additional detectable events.

Referring to FIG. 1, a method of detecting an event according to an example embodiment of the present invention may be divided into a first operation of distinguishing data according to object, a second operation of applying object-specific data to object-specific deterministic finite automata (DFA), and a third operation of generating event information based on the DFA. Here, each operation is intended for convenience of description, and the method may be divided into subdivided or comprehensive operations. Each operation will be described in detail below.

In the first operation of the method of detecting an event according to an example embodiment of the present invention, object-specific data may be extracted from soccer video data. Here, the soccer video data may denote frame-specific data and include at least one object. Also, the object-specific data may denote data distinguished according to a referee, assistant referees, players, and a ball. The object-specific data may denote object-specific position information and size information or object-specific motion information extracted based on the object-specific position information and size information. In other words, in the first operation, object tracking, object classification, motion recognition, and the like are performed to extract object-specific data from soccer video data.

In the second operation, object-specific states may transition based on object-specific data extracted according to predefined object-specific DFA. In other words, DFA may be defined in advance according to a referee, assistant referees, players, and a ball, and states of the referee, the assistant referees, the players, and the ball may transition based on data according to the referee, the assistant referees, the players, and the ball. Here, a DFA is a mathematical model that may have a finite number of states and may denote a model that may have only one state at a time, that is, may not simultaneously have a plurality of states. In other words, a DFA may denote a model in which a specific object transitions from one state to another state due to a certain event.

In the third operation, when a state of an object becomes a final state of a DFA, it is determined that an event corresponding to the final state has occurred. Therefore, it is possible to detect the event and generate information on the detected event. Here, the event may occur in different ways according to object, and when a state of an object becomes a final state, the state of the object may transition to a start state. Also, the generated event information may include detailed event information, such as a motion start time point, a team, and the like, and may be recorded or stored in a database.

Detailed operations of a method of detecting an event according to an example embodiment of the present invention will be described below with reference to FIG. 2.

FIG. 2 is a block diagram of an apparatus for detecting an event according to an example embodiment of the present invention.

Referring to FIG. 2, an apparatus 200 for detecting an event according to an example embodiment of the present invention may include at least one processor 210, a memory 220, and a storage device 230.

The processor 210 may execute a program command stored in the memory 220 and/or the storage device 230. The processor 210 may denote a central processing unit (CPU), a graphics processing unit (GPU), or a dedicated processor for performing methods according to the present invention. The memory 220 and the storage device 230 may be a volatile storage medium and/or a non-volatile storage medium. For example, the memory 220 may be a read only memory (ROM) and/or a random access memory (RAM).

The memory 220 may store at least one command executed by the processor 210. The at least one command may include a command to extract at least one of position information and motion information of at least one object from a soccer video including the at least one object, a command to cause a state of the at least one object to transition based on at least one of the position information and the motion information of the at least one object according to object-specific state transition rules, and a command to detect a soccer event corresponding to a final state when the state of the at least one object becomes the final state. The at least one command may further include a command to record a detected event corresponding to a final state together with detailed event information of the event.

The processor 210 may receive soccer video data from a data acquirer 100. Here, the soccer video data may be frame-specific data and may denote data including at least one object.

The processor 210 may extract at least one of position information and motion information of at least one object from a soccer video including the at least one object according to a command stored in the memory 220. More specifically, the processor 210 may extract position information and size information of at least one object by tracking the at least one object from a soccer video according to a command stored in the memory 220, and extract motion information of the at least one object based on the position information and the size information of the at least one object.

Here, tracking may be performed according to object. However, objects included in soccer video data are persons, such as a referee, assistant referees, and players, and an object, such as a ball. Therefore, a method or setting for tracking a person and a method or setting for tracking a thing may differ from each other, and may be performed by separate modules. Also, an apparatus capable of simultaneously tracking a plurality of objects may be used for tracking. A method of tracking an object may be a general tracking method, but is not limited thereto.

In other words, the processor 210 may acquire position information by tracking an object, such as a ball, as described above, and acquire position information and size information by tracking persons, such as a referee, assistant referees, and players, as described above. However, when an object is a person, additional information such as motion information may be required, and it may be required to classify persons for tracking because persons are not classified into a referee, assistant referees, and players.

With regard to this, the processor 210 may distinguish position information and size information of objects that are persons, such as a referee, assistant referees, and players, according to object. In other words, the processor 210 may classify and acquire position information and size information of the referee, position information and size information of the assistant referees, and position information and size information of the players. Here, each object may be classified using color or machine learning. However, a method of classifying each object is not limited thereto, and any general method of classifying an object in an image may be used.

The processor 210 may extract object-specific motion information using position information and size information distinguished according to object. In other words, the processor 210 may extract motion information of the referee based on position information and size information of the referee, extract motion information of the assistant referees based on position information and size information of the assistant referees, and extract motion information of the players based on position information and size information of the players. Here, a method of extracting motion information using position information and size information may be a general method, but is not limited thereto.

In response to a command stored in the memory 220, the processor 210 may cause a state of at least one object to transition based on position information and motion information of the at least one object according to pre-defined state transition rules. More specifically, the processor 210 may cause the state of the at least one object to transition using object-specific pre-defined DFA according to a command stored in the memory 220.

A DFA may be a state model in which states distinguishable based on position information and motion information of an object are defined, and may be defined differently according to object. A method of transitioning a state of an object based on position information and motion information of the object using a DFA will be described below. Although one object will be described as an example, individual objects may be distinguished and separately transition in state. State transition of individual objects may be simultaneously performed.

A state of an object may be a start state, and when a specific condition is satisfied, the state of the object may transition from the start state to another state. Also, when another specific condition is satisfied, the state of the object may transition from the other state to still another state. When the state of the object becomes a final state, it may be determined that an event corresponding to the final state has occurred for the object, and the event may be detected.

An arbitrary DFA M may be defined by Equation 1, and each factor may be defined differently according to object.

[Equation 1]

M=(Q, Σ, δ, q₀, F)

In Equation 1, Q may denote a finite set of states, and Σ may denote input data that is a basis of state transition. δ may denote a state transition function, q₀ may denote a start state, and F may denote a final state.

In other words, in object-specific DFA for detecting an event in a soccer video, Q may denote a set of at least one state to which a state of an object may transition, Σ may denote least one of position information and motion information of the object. δ may denote a state transition table and satisfy δ: Q×Σ→Q. go may denote a start state of the object and satisfy q₀∈Q. F may denote a final state of the object and may satisfy F⊆Q.

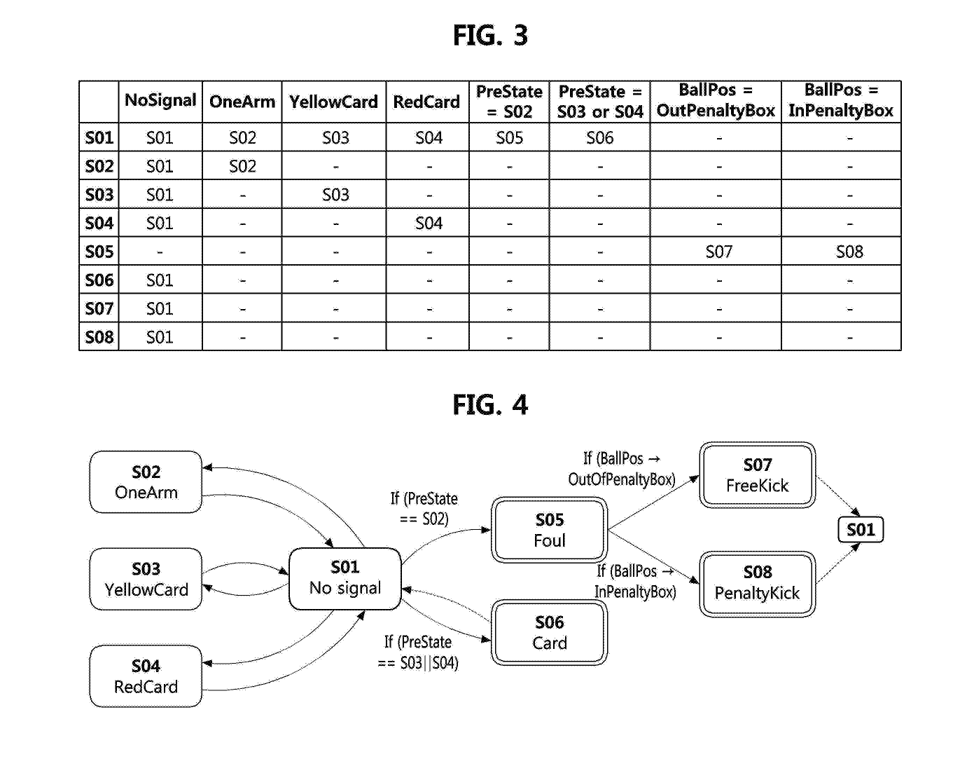

State transition of an object according to a pre-defined DFA will be described in detail below with reference to FIGS. 3 and 4.

When a state of at least one object becomes a final state according to a command stored in the memory 220, the processor 210 may detect an event corresponding to the final state of the object, and continuously cause the state of the at least one object to transition according to pre-defined state transition rules based on at least one of next position information and next motion information of the at least one object.

In other words, the processor 210 may continuously cause a state of an object to transition based on at least one of position information and motion information of the object, and when the state of the object becomes a final state, the processor 210 may determine that an event corresponding to the final state of the object has occurred and detect the occurred event.

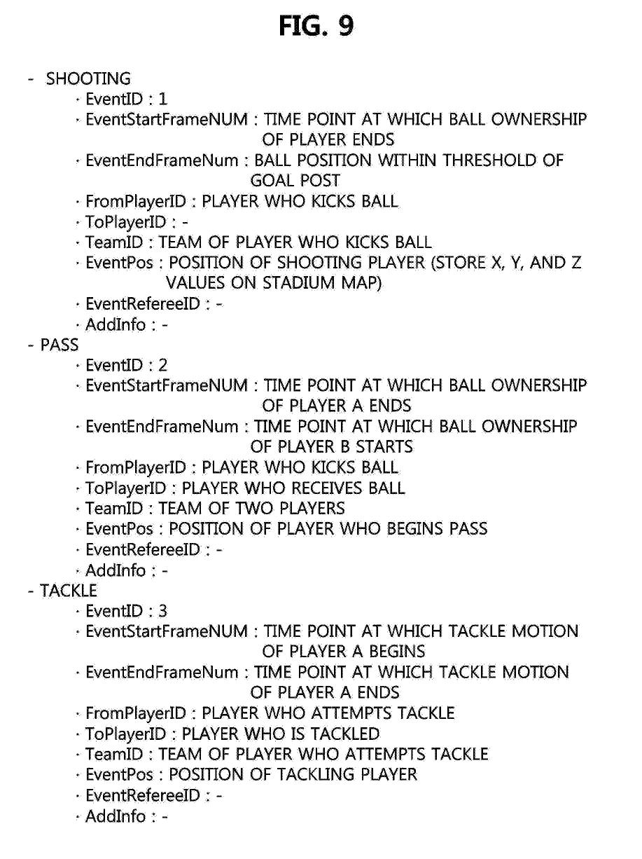

The processor 210 may record the detected event corresponding to the final state together with detailed event information according to a command stored in the memory 220. Event-specific detailed information will be described below with reference to FIGS. 9 to 13.

FIG. 3 is a state transition function table of a referee

FIG. 4 is a diagram showing a referee DFA according to an example embodiment of the present invention.

A method of detecting an event according to an example embodiment of the present invention will be described with an example of a referee DFA. A DFA MR that is a pre-defined DFA of a referee may be defined by Equation 2.

[Equation 2]

MR=(Q, Σδ, q₀, F)
where,
Q={(S01, S02, S03, S04, S05, S06, S07, S08}
Σ={Referee Motion, PreState, BallPos}
q₀=S01
F={S05, S06, S07, S08}
δ=state transition table of FIG. 3

In Equation 2, δ may denote a state transition table of FIG. 3, and state transition of a referee according to FIGS. 3 and 4 will be described below.

First, a state of a referee may be at S01 (Nosignal) that is a start state. Here, the state of the referee may remain at S01 when motion information not related to any event, such as walking, running, indicating with two arms, and the like, is extracted.

When information on the referee's motion of raising one arm is extracted, the state of the referee may transition from S01 to S02 (OneArm). Subsequently, when motion information not related to any event is extracted, the state of the referee may transition from S02 to S01. When a previous state of the referee is S02, the state of the referee may transition from S01 to S05 (Foul).

The state of the referee transitioned to S05 may transition to a next state based on position information of a ball. In other words, when position information of the ball indicating that the ball is outside a penalty box is extracted, the state of the referee may transition to S07 (FreeKick), and when position information of the ball indicating that the ball is in a penalty box is extracted, the state of the referee may transition to S08 (PenaltyKick). Subsequently, when motion information not related to any event is extracted, the state of the referee may transition to S01 that is the start state.

Also, the state of the referee present at S01 that is the start state may transition to S03 (YellowCard) when information on the referee's motion of raising a yellow card is extracted, and may transition to S04 (RedCard) when information on the referee's motion of raising a red card is extracted. Subsequently, when motion information not related to any event is extracted, the state of the referee may transition from S04 to S01. When a previous state of the referee is S03 or S04, the state of the referee may transition from S01 to S06 (Card). The state of the referee transitioning to S06 may transition back to S01 that is the start state when motion information not related to any event is extracted.

Referring to FIG. 4, PreState may denote a previous state of the referee, and BallPos may denote a position of the ball. Also, OutOfPenaltyBox may denote a position outside a penalty box, and InPenaltyBox may denote a position in a penalty box.

Among the states of the referee, S01 may denote the start state, S02, S03, and S04 may denote intermediate states, and S05, S06, S07, and S08 may denote final states. The start state, the intermediate states, and the final states may be set in advance and may also be changed according to setting.

A transitioning process in which the state of the referee transitions from the start state S01 to a final state S05, S06, S07, or S08 may be arranged as follows.
Foul: S01→S02→S01→S05
Card: S01→S03 or S04→S01→S06
FreeKick: S01→S02→S01→S05→S07
PenaltyKick: S01→S02→S01→S05→S08

When the state of the referee becomes a final state S05, S06, S07, or S08, the apparatus 200 for detecting an event according to an example embodiment of the present invention may determine that an event corresponding to the final state has occurred and may record event information including detailed event information. Information included in detailed event information will be described below with reference to FIGS. 9 to 13.

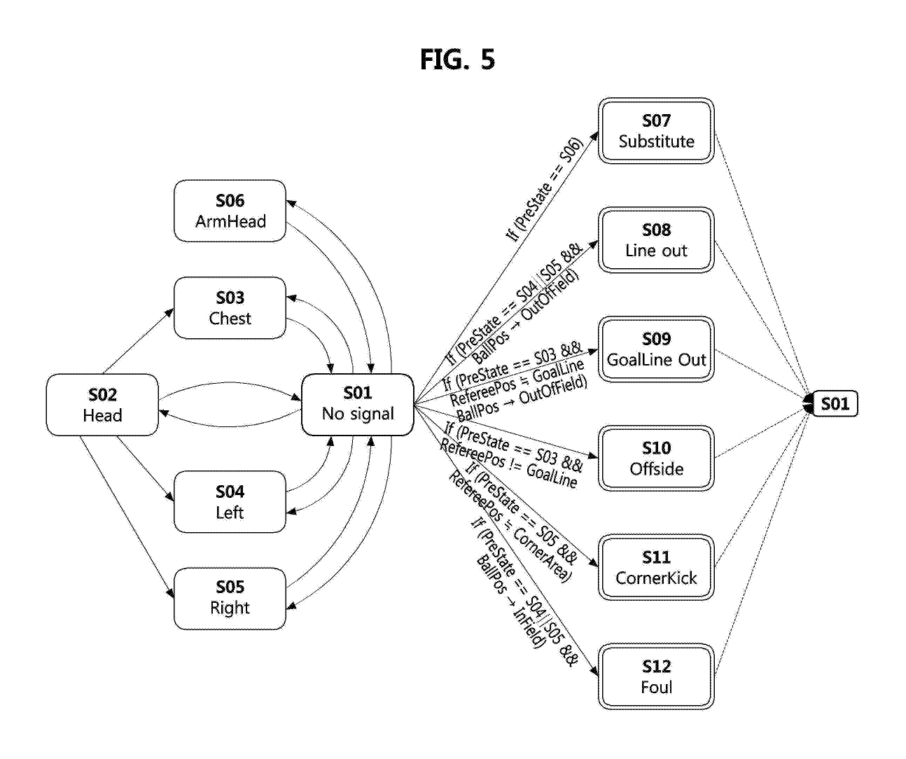

FIG. 5 is a diagram showing an assistant referee DFA according to an example embodiment of the present invention.

A method of detecting an event according to an example embodiment of the present invention will be described with an example of an assistant referee DFA with reference to FIG. 5.

First, a state of an assistant referee may be at S01 (Nosignal) that is a start state. Here, the state of the assistant referee may remain at S01 when motion information not related to any event, such as walking, running, sidling, and the like, is extracted.

When information on the assistant referee's motion of raising a flag above his or her head is extracted, the state of the assistant referee may transition from S01 to S02 (Head). Subsequently, the state of the assistant referee may transition from S02 to S03 (Chest) when information on the assistant referee's motion of raising the flag forward at the height of his or her chest is extracted, may transition from S02 to S04 (Left) when information on the assistant referee's motion of raising the flag to the left is extracted, and may transition from S02 to S05 (Right) when information on the assistant referee's motion of raising the flag to the right is extracted.

The state of the assistant referee may transition from S01 to S03 when information on the assistant referee's motion of raising the flag forward at the height of his or her chest is extracted in S01 that is the start state, and may transition from S01 to S04 when information on the assistant referee's motion of raising the flag to the left. Also, the state of the assistant referee may transition from S01 to S05 when information on the assistant referee's motion of raising the flag to the right is extracted in S01 that is the start state, and may transition from S01 to S06 when information on the assistant referee's motion of raising the flag upward with his or her both hands.

The state of the assistant referee present at any one of S02, S03, S04, S05, and S06 may transition to S01 when motion information not related to any event is extracted.

In this case, the state of the assistant referee may transition from S01 to S07 (Substitute) when a previous state of the assist referee is S06, and may transition from S01 to S08 (Line Out) when the previous state of the assist referee is S04 or S05 and position information of a ball indicating that the ball is outside a field is extracted. The state of the assistant referee may transition from S01 to S09 (GoalLine Out) when the previous state of the assist referee is S03 and position information of the assistant referee indicating that the assistant referee is within a certain distance from a goal line and position information of the ball indicating that the ball is outside the field is extracted. The state of the assistant referee may transition from S01 to S10 (Offside) when the previous state of the assist referee is S03 and position information of the assistant referee indicating that the assistant referee is within a certain distance from a goal line is extracted, and may transition from S01 to S11 (CornerKick) when the previous state of the assist referee is S05 and position information of the assistant referee indicating that the assistant referee is within a certain distance from a corner in the field is extracted. Also, the state of the assistant referee may transition from S01 to S12 (Foul) when the previous state of the assist referee is S04 or S05 and position information of the ball indicating that the ball is in the field is extracted.

The state of the assistant referee present at any one of S07, S08, S09, S10, S11, and S12 may transition back to S01 when motion information not related to any event is extracted.

Referring to FIG. 5, PreState may denote a previous state of the assistant referee, and BallPos may denote a position of the ball. Also, OutOfField may denote a position outside the field, and InField may denote a position in the field. GoalLine may denote a position of a goal line, CornerArea may denote a position of a corner in the field, and RefereePos may denote a position of the assistant referee.

Among the states of the assistant referee S01 may denote the start state, S02, S03, S04, S05, and S06 may denote intermediate states, and S07, S08, S09, S10, S11, and S12 may denote final states. The start state, the intermediate states, and the final states may be set in advance and may also be changed according to setting.

When the state of the referee becomes a final state S07, S08, S09, S10, S11 or S12 the apparatus 200 for detecting an event according to an example embodiment of the present invention may determine that an event corresponding to the final state has occurred and may record event information including detailed event information. Information included in detailed event information will be described below with reference to FIGS. 9 to 13.

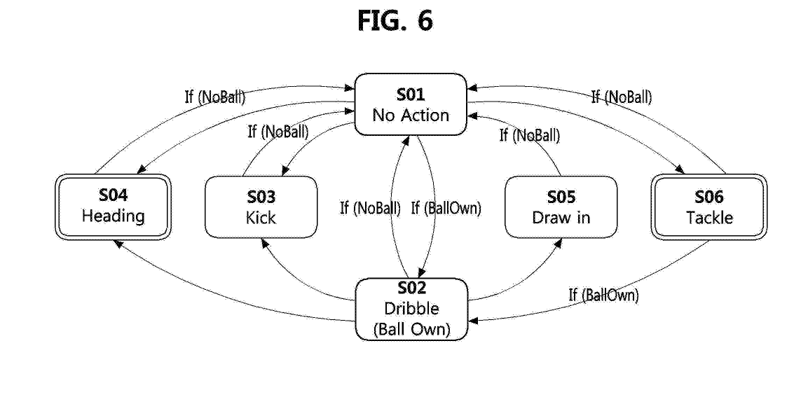

FIG. 6 is a diagram showing a player DFA according to an example embodiment of the present invention.

A method of detecting an event according to an example embodiment of the present invention will be described with an example of a player DFA with reference to FIG. 6.

First, a state of a player may be at S01 (No Action) or S02 (Dribble) as a start state. Here, the state of the player may be at S01 when motion information that is generated without a ball and is not related to any event, such as walking, running, putting his or her hand on his or her waist, and the like, is extracted, and may be at S02 when motion information that is generated with a ball and is not related to any event, such as walking and running, is extracted.

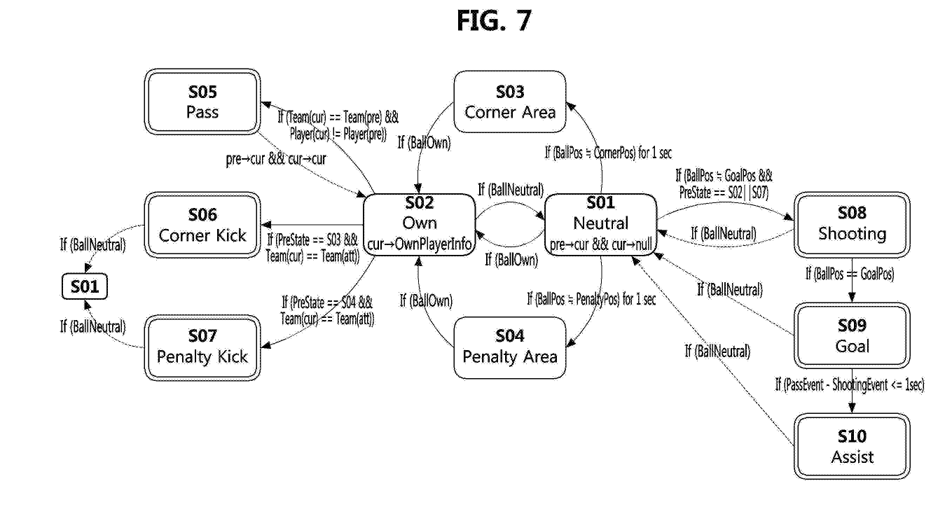

The state of the player present at S01 that is a start state may transition to S02 when information indicating that the player has the ball is extracted, and the state of the player present at S02 that is a start state may transition to S01 when information indicating that the player does not have the ball is extracted. It may be determined whether the player has the ball according to a pre-defined method, which will be described in detail below with reference to FIG. 7.

The state of the player present at S01 that is a start state may transition to S03 (Kick) when motion information of the player's kick is extracted, and may transition to S04 (Heading) when motion information of the player's heading is extracted. Also, the state of the player present at S01 that is a start state may transition to S05 (Throw in) when motion information of the player's throw-in is extracted, and may transition to S06 (Tackle) when motion information of the player's tackle is extracted.

The state of the player present at S02 that is a start state may transition to S03 (Kick) when motion information of the player's kick is extracted, and may transition to S04 (Heading) when motion information of the player's heading is extracted. Also, the state of the player present at S02 that is a start state may transition to S05 (Throw in) when motion information of the player's throw-in is extracted.

The state of the player present at any one of S03, S04, S05, and S06 may transition to S01 when information indicating that the player does not have the ball is extracted. Also, the state of the player present at S06 may transition to S02 when information indicating that the player has the ball is extracted.

Referring to FIG. 6, NoBall may denote a state in which the player does not have the ball, and BallOwn may denote a state in which the player has the ball.

Among the states of the player, S01 and S02 may denote the start states, S03 and S05 may denote intermediate states, and S04 and S06 may denote final states. The start states, the intermediate states, and the final states may be set in advance and may also be changed according to setting.

When the state of the player becomes a final state S04 or S06, the apparatus 200 for detecting an event according to an example embodiment of the present invention may determine that an event corresponding to the final state has occurred and may record event information including detailed event information. Information included in detailed event information will be described below with reference to FIGS. 9 to 13.

FIG. 7 is a diagram showing a ball DFA according to an example embodiment of the present invention.

A method of detecting an event according to an example embodiment of the present invention will be described with an example of a ball DFA with reference to FIG. 7.

First, a state of a ball may be at S01 (Neutral) or S02 (Own) as a start state. When a player who currently owns the ball becomes a player who just owned the ball and information indicating that there is no information on a player who currently owns the ball is extracted, it is determined that the ownership of the ball is neutral, and the state of the ball may be at S01. When information indicating that a player has the ball is extracted, the state of the ball may be at S02.

The state of the ball present at S01 that is a start state may transition to S02 when information indicating that the ownership of the ball is neutral is extracted, and the state of the ball present at S02 that is a start state may transition to S01 when information indicating that a player has the ball is extracted.

The state of the ball present at S01 that is a start state may transition to S03 (Corner Area) when position information of the ball indicating that the ball is within a certain distance from a corner in the field is continuously extracted for one second, and may transition to S04 (Penalty Area) when position information of the ball indicating that the ball is within a certain distance from a penalty position is continuously extracted for one second. Also, the state of the ball present at S03 or S04 may transition to S02 when information indicating that a player has the ball is extracted.

The state of the ball present at S01 that is a start state may transition to S08 (Shooting) when position information of the ball indicating that the ball is within a certain distance from a goal post in the field is extracted and a previous state of the ball is S02 or S07 (Penalty Kick).

The state of the ball present at S08 may transition to S09 (Goal) when position information of the ball indicating that the ball is outside the goal line between goal posts in the field is extracted, and may transition back to S01 when information indicating that the ownership of the ball is neutral is extracted.

The state of the ball present at S09 may transition to S10 (Assist) when information indicating that a difference between an occurrence time of a pass event and an occurrence time of the shooting event is 1 second or less is extracted, and may transition back to S01 when information indicating that the ownership of the ball is neutral is extracted.

The state of the ball present at S10 may transition back to S01 when information indicating that the ownership of the ball is neutral is extracted.

The state of the ball present at S02 that is a start state may transition to S05 (Pass) when a player who currently owns the ball belongs to the same team as a player who just owned the ball and information indicating that the player who currently owns the ball and the player who just owned the ball are different players is extracted, and may transition to S06 (Corner Kick) when a previous state of the ball is S03 and information indicating that the player who currently owns the ball belongs to an attacking team is extracted. Also, the state of the ball present at S02 that is a start state may transition to S07 (Penalty Kick) when a previous state of the ball is S04 and information indicating that the player who currently owns the ball belongs to an attacking team is extracted.

The state of the ball present at S05 may transition to S02 when a player who currently owns the ball belongs to the same team as a player who just owned the ball and information indicating that the player who currently owns the ball differs from the player who just owned the ball is extracted.

The state of the ball present at S06 or S07 may transition to S01 when information indicating that the ownership of the ball is neutral is extracted.

Referring to FIG. 7, PreState may denote a previous state of the ball, BallNeutral may denote a state in which the ownership of the ball is neutral, and BallOwn may denote a state in which a specific player has the ball. Also, BallPos may denote a position of the ball, CornerPos may denote a position of a corner in the field, and PenaltyPos may denote a penalty position in the field. GoalPos may denote positions of goal posts in the field, PassEvent may denote an occurrence time of a pass event, and ShootingEvent may denote an occurrence time of a shooting event. Also, Team (cur) may denote a team of a player who currently has the ball, Team (pre) may denote a team of a player who just had the ball, and Team (att) may denote a team that currently attacks. “cur” may denote information on a player who currently has the ball, and “pre” may denote information on a player who just had the ball. “cur” and “pre” may be used as variables, and when the ownership of the ball is changed, it is possible to continuously store or record information on players who had the ball.

Among the states of the ball, S01 and S02 may denote the start states, S03 and S04 may denote intermediate states, and S05, S06, S07, S08, S09, and S10 may denote final states. The start states, the intermediate states, and the final states may be set in advance and may also be changed according to setting.

When the state of the ball becomes a final state S05, S06, S07, S08, S09, or S10, the apparatus 200 for detecting an event according to an example embodiment, of the present invention may determine that an event corresponding to the final state has occurred and may record event information including detailed event information. Information included in detailed event information will be described below with reference to FIGS. 9 to 13.

The apparatus 200 for detecting an event according to an example embodiment of the present invention may determine that a player has the ball according to Equation 3. However, a basis for making the determination is not limited thereto, and the determination may be made in various ways.

[Equation 3]

|BallPos-PlayerPos|<0.5 m && BallVectorChanged

Referring to Equation 3, a basis for determining that a player has the ball may be defined as a difference between the position of the ball and the position of the player being smaller than 0.5 m and also BallVectorChanged occurring.

Here, it is possible to assume that BallVectorChanged occurs when the direction of the ball is changed by 15 degrees or more or the speed of the ball increases or decreases by 1.5 times or more during an arbitrary unit of time.

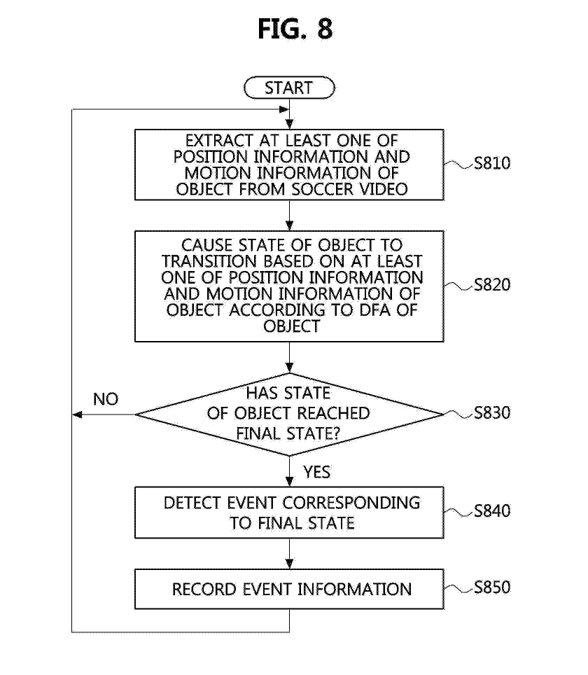

FIG. 8 is a flowchart of a method of detecting an event according to an example embodiment of the present invention.

Referring to FIG. 8, in a method of detecting an event according to an example embodiment of the present invention, position information and motion information of an object may be extracted from a soccer video first (S810). Here, the soccer video may be a video including at least one object and may denote frame-specific data. Also, the apparatus 200 for detecting an event may extract position information and size information of objects by tracking the objects, classify the position information and the size information according to object, and then extract object-specific motion information based on the object-specific position information and size information.

Subsequently, in the method of detecting an event, at least one of the object-specific position information and motion information is input to object-specific DFA such that a state of the object may transition (S820). In the DFA, start states, intermediate states, final states, transition conditions, and the like may be pre-defined according to object.

In the method of detecting an event, it may be determined whether the state of the object has become a final state (S830), and when the state of the object has not become a final state, it is possible to extract next position information and next motion information of the object from the continuous soccer video (S810).

However, when the state of the object becomes a final state, it is possible to detect an event corresponding to the final state (S840), and record event information (S850). Here, the event information may be recorded together with detailed event information.

In the method of detecting an event, after the event information is recorded, it is possible to extract next position information and next motion information of the object from the continuous soccer video (S810).

FIG. 9 shows detailed event information of shooting, pass, and tackle according to an example embodiment of the present invention.

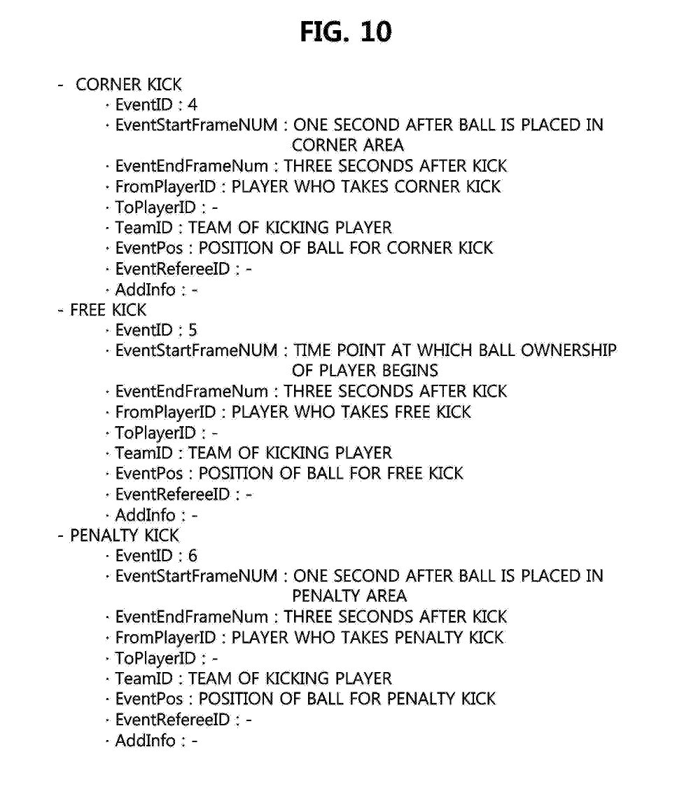

FIG. 10 shows detailed event information of corner kick, free kick, and penalty kick according to an example embodiment of the present invention.

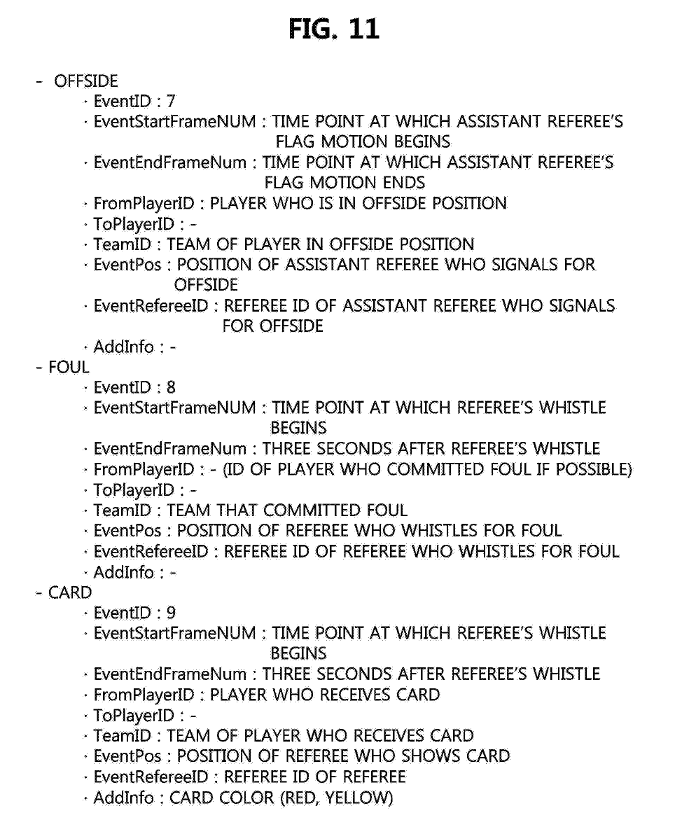

FIG. 11 shows detailed event information of offside, foul, and card according to an example embodiment of the present invention.

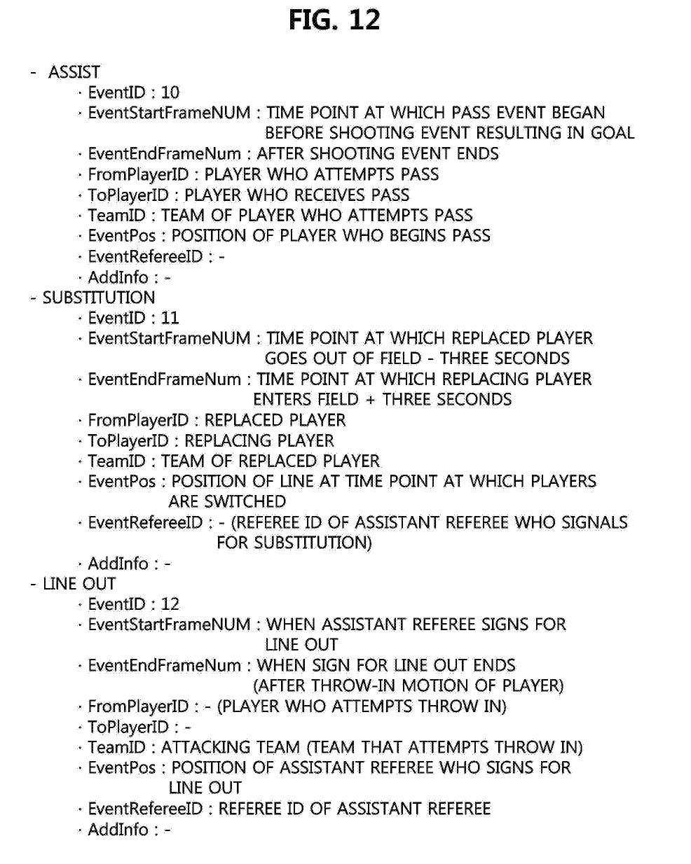

FIG. 12 shows detailed event information of assist, substitution, and line out according to an example embodiment of the present invention.

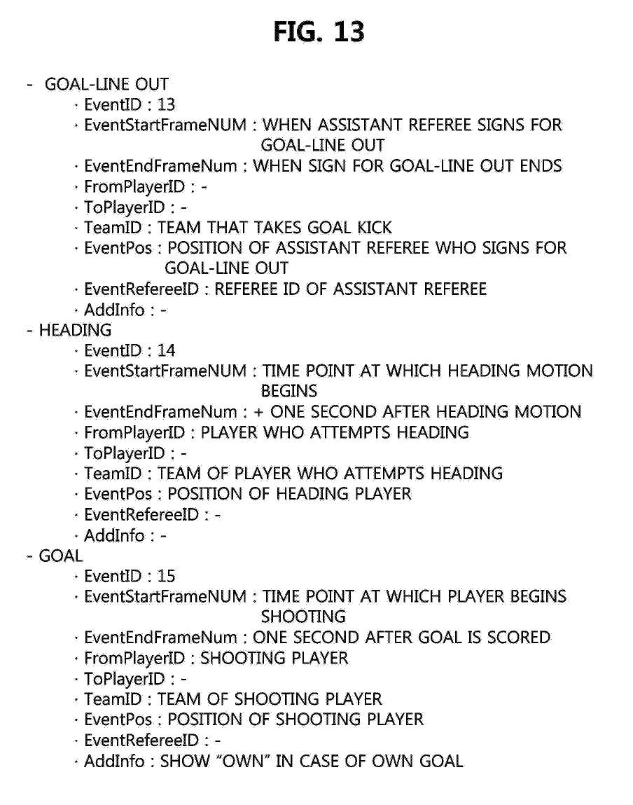

FIG. 13 shows detailed event information of goal-line out, heading, and goal according to an example embodiment of the present invention.

Event detectable by the apparatus 200 for detecting an event according to an example embodiment of the present invention may include shooting, pass, tackle, corner kick, free kick, penalty kick, offside, foul, card, assist, substitution, line out, goal-line out, heading, and goal. Referring to FIGS. 9 to 13, individual events may have different detailed event information.

Detailed event information may be included in event information that is recorded or stored when an event is detected. Event information including detailed event information may be stored in a structured data structure, and then specific event information or all event information may be extracted from the structured data structure and output and provided to a user.

Detailed event information may have the following formats.
Event ID: an event identifier (ID)
EventStartFrameNum: a frame number at which an event starts
EventEndFrameNum: a frame number at which an event ends
FromPlayerID: an ID of a player who causes an event
ToPlayerID: an ID of a player who ends an event
TeamID: an ID of a team related to an event
EventPos: a position in a field at which an event occurs
EventRefereeID: an ID of a referee related to an event
AddInfo: a variable in which information additionally required by an event is stored

Here, detailed event information is not limited to the above-described formats or FIGS. 9 to 13, and may be changed.

As an example embodiment of an apparatus for detecting an event according to the present invention, detection of events in a soccer game has been described above, but the apparatus is not limited thereto. The apparatus can be applied not only to soccer but also to any sports in which events of similar patterns occur, and can be used in application fields based on image understanding such as closed-circuit television (CCTV)-based action analysis.

While the example embodiments of the present invention and their advantages have been described in detail, it should be understood that various changes, substitutions and alterations may be made herein without departing from the scope of the invention.

What is claimed is:

1. A method of detecting an event, the method comprising:
extracting at least one of position information and motion information of at least one object from a soccer video including the at least one object;
causing a state of the at least one object to transition based on at least one of the position information and the motion information of the at least one object according to object-specific state transition rules; and
when the state of the at least one object becomes a final state, detecting a soccer event corresponding to the final state.

2. The method of claim 1, further comprising, until a soccer game is finished, repeatedly performing the extracting of the at least one of the position information and the motion information, the causing of the state of the at least one object to transition, and the detecting of the soccer event.

3. The method of claim 1, wherein the causing of the state of the at least one object to transition according to the object-specific state transition rules comprises causing the state of the at least one object to transition using pre-defined object-specific deterministic finite automata (DFA).

4. The method of claim 1, wherein the extracting of the at least one of the position information and the motion information comprises extracting the position information and size information of the at least one object from the soccer video by tracking the at least one object.

5. The method of claim 4, wherein the extracting of the at least one of the position information and the motion information further comprises extracting motion information of the at least one object based on the position information and the size information of the at least one object.

6. The method of claim 5, wherein the extracting of the motion information of the at least one object based on the position information and the size information comprises:
classifying the position information and the size information of the at least one object according to object; and
extracting object-specific motion information based on the position information and the size information classified according to object.

7. The method of claim 1, wherein the causing of the state of the at least one object to transition according to the object-specific state transition rules comprises, when the object is a ball, causing a state of the ball to transition based on a distance between the ball and a specific player, a directional change of the ball, and a speed of the ball according to state transition rules of the ball.

8. The method of claim 1, further comprising recording the detected event corresponding to the final state together with detailed information of the event.

9. The method of claim 8, wherein the detailed information of the event includes at least one of a name of the event, a start frame number of the event, an end frame number of the event, a name of a player who has caused the event, a name of a player who has ended the event, a name of a team that has caused the event, a position at which the event has occurred, and a name of a referee or an assistant referee who has caused the event.

10. The method of claim 1, wherein the soccer event corresponding to the final state includes any one of foul, card, free kick, and penalty kick when the object is a referee, includes any one of substitution, line out, goal-line out, offside, corner kick, and foul when the object is an assistant referee, includes any one of heading and tackle when the object is a player, and includes any one of pass, corner kick, penalty kick, shooting, goal, and assist when the object is a ball.

11. An apparatus for detecting an event, comprising:
a processor; and
a memory configured to store at least one command executed by the processor,
wherein the at least one command is executed to:
extract at least one of position information and motion information of at least one object from a soccer video including the at least one object;
cause a state of the at least one object to transition based on at least one of the position information and the motion information of the at least one object according to object-specific state transition rules; and
detect a soccer event corresponding to a final state when the state of the at least one object becomes the final state.

12. The apparatus of claim 11, wherein the at least one command is executed to repeatedly extract at least one of the position information and the motion information, repeatedly cause the state of the at least one object to transition, and repeatedly detect the soccer event until a soccer game ends.

13. The apparatus of claim 11, wherein the at least one command is executed to cause the state of the at least one object to transition using pre-determined object-specific deterministic finite automata (DFA).

14. The apparatus of claim 11, wherein the at least one command is executed to extract the position information and size information of the at least one object from the soccer video by tracking the at least one object.

15. The apparatus of claim 14, wherein the at least one command is executed to extract motion information of the at least one object based on the position information and the size information of the at least one object.

16. The apparatus of claim 15, wherein the at least one command is executed to classify the position information and the size information of the at least one object according to object and to extract object-specific motion information based on the position information and the size information classified according to object.

17. The apparatus of claim 11, wherein the at least one command is executed to cause, when the at least one object is a ball, a state of the ball to transition based on a distance between the ball and a specific player, a directional change of the ball, and a speed of the ball according to state transition rules of the ball.

18. The apparatus of claim 11, wherein the at least one command is executed to record the detected event corresponding to the final state together with detailed information of the event.

19. The apparatus of claim 18, wherein the detailed information of the event includes at least one of a name of the event, a start frame number of the event, an end frame number of the event, a name of a player who has caused the event, a name of a player who has ended the event, a name of a team that has caused the event, a position at which the event has occurred, and a name of a referee or an assistant referee who has caused the event.

20. The apparatus of claim 11, wherein the soccer event corresponding to the final state includes any one of foul, card, free kick, and penalty kick when the object is a referee, includes any one of substitution, line out, goal-line out, offside, corner kick, and foul when the object is an assistant referee, includes any one of heading and tackle when the object is a player, and includes any one of pass, corner kick, penalty kick, shooting, goal, and assist when the object is a ball.
